(19) United States
(12) Patent Application Publication
(10) Pub. No.: US 2026/0360120 A1
(43) Pub. Date: Nov. 12, 2026

(54) IMAGE PROCESSING METHOD AND APPARATUS

(71) Applicants: SAMSUNG ELECTRONICS CO., LTD., Suwon-si (KR); SEOUL NATIONAL UNIVERSITY R&DB FOUNDATION, Seoul (KR)

(72) Inventors: Haeyoon Yang, Seoul (KR); Nam Ik Cho, Seoul (KR); Jae Hoon Shim, Seoul (KR); Jaekyung Ryu, Seongnam-si (KR); Hyoa Kang, Suwon-si (KR); Dokwan Oh, Suwon-si (KR); Young Hun Sung, Suwon-si (KR)

(73) Assignees: SAMSUNG ELECTRONICS CO., LTD., Suwon-si (KR); SEOUL NATIONAL UNIVERSITY R&DB FOUNDATION, Seoul (KR)

(21) Appl. No.: 19/424,727

(22) Filed: Dec. 18, 2025

(30) Foreign Application Priority Data
May 9, 2025 (KR) 10-2025-0060179
Jul. 30, 2025 (KR) 10-2025-0104227

(51) Int. Cl. G06V 10/77; G06V 10/72; G06V 10/776; G06V 10/82

(52) U.S. Cl. CPC G06V 10/7715; G06V 10/72; G06V 10/776; G06V 10/82

(57) ABSTRACT

An image processing method, a computing apparatus, and a computer program are provided. The image processing method includes obtaining an input image corresponding to a frame index, the input image representing one frame of an image sequence, obtaining a first feature map from the input image, generating an intermediate feature map by upsampling the first feature map, generating a mask related to a high-frequency component corresponding to the intermediate feature map, calibrating the intermediate feature map based on the mask; and outputting a second feature map by performing at least one convolution operation on the calibrated intermediate feature map.

### CROSS-REFERENCE TO RELATED APPLICATIONS

This application claims priority from Korean Patent Application No. 10-2025-0060179, filed on May 9, 2025, and Korean Patent Application No. 10-2025-0104227, filed on Jul. 30, 2025, in the Korean Intellectual Property Office, the entire disclosures of which are incorporated herein by reference for all purposes.

### BACKGROUND

### 1. Field

The present disclosure relates to image processing methods and apparatus.

### 2. Description of the Related Art

Video is generally structured to record visual information changing over time as a sequence of consecutive frames. Mathematically, each frame can be represented as a function that maps two-dimensional spatial coordinates (x, y) to corresponding red, green, and blue (RGB) values.

Recently, neural network-based approaches have been explored for representing entire image information as a method for compressing or representing video data. Accordingly, a pixel-level representation method has been used that receives all pixel coordinates of each frame as input and outputs RGB values of corresponding pixels. Additionally, a frame-level representation method in the form of a neural network-based function has been proposed that receives a temporal index as input and generates an entire frame at the corresponding time point. This frame-level approach is based on a concept of implicit neural representation (INR), which models entire signals with neural networks for coordinate-based inputs.

### SUMMARY

One or more embodiments may address at least the above problems and/or disadvantages and other disadvantages not described above. Also, the embodiments are not required to overcome the disadvantages described above, and one or more embodiments may not overcome any of the problems described above.

In one or more embodiments, an image processing method may include: obtaining an input image corresponding to a frame index; obtaining a first feature map from the input image; generating an intermediate feature map by upsampling the first feature map; generating a mask related to a high-frequency component corresponding to the intermediate feature map, the high-frequency component being greater than a predetermined upper frequency threshold; calibrating the intermediate feature map based on the mask; and outputting a second feature map by performing at least one convolution operation on the calibrated intermediate feature map.

In one or more embodiments, a neural network training method may include: (1) executing at least one neural network to: obtain a first feature map corresponding to a frame index; generate an intermediate feature map by upsampling the first feature map; generate a mask related to a high-frequency component corresponding to the intermediate feature map, the high-frequency component being greater than a predetermined upper frequency threshold; calibrate the intermediate feature map based on the mask; and output a second feature map by performing at least one convolution operation on the calibrated intermediate feature map; (2) calculating a first loss of the neural network based on an image frame corresponding to the second feature map and a ground-truth frame corresponding to the frame index; (3) generating a ground-truth mask related to the high-frequency component, based on the ground-truth frame; (4) calculating a second loss of the neural network based on the mask and the ground-truth mask; and (5) updating training parameters of the neural network based on at least one of the first loss and the second loss.

In one or more embodiments, a computing apparatus for providing image processing, may include: at least one processor; and at least one memory storing one or more instructions. The one or more instructions, when executed by the at least one processor, may cause the computing apparatus to perform: obtaining an input image corresponding to a frame index; obtaining a first feature map from the input image; generating an intermediate feature map by upsampling the first feature map; generating a mask related to a high-frequency component corresponding to the intermediate feature map, the high-frequency component being greater than a predetermined upper frequency threshold; calibrating the intermediate feature map based on the mask; and outputting a second feature map by performing at least one convolution operation on the calibrated intermediate feature map.

### BRIEF DESCRIPTION OF THE DRAWINGS

The above and/or other aspects will be more apparent by describing certain embodiments with reference to the accompanying drawings, in which:

FIG. 1 is a diagram illustrating a neural network-based image processing flow according to one or more embodiments;

FIG. 2 is a diagram illustrating a neural network architecture according to one or more embodiments;

FIG. 3 is a diagram illustrating a structure of an operation block according to one or more embodiments;

FIG. 4 is a diagram illustrating a structure of mask generation and application according to one or more embodiments;

FIG. 5 is a diagram illustrating a configuration of a multi-resolution temporal grid and an embedding structure by temporal interpolation according to one or more embodiments;

FIG. 6 is a diagram illustrating an implementation method of an interpolation structure based on an adaptive temporal coordinate according to one or more embodiments;

FIG. 7 is a diagram illustrating an overall flow of an image processing method according to one or more embodiments;

FIG. 8A is a diagram illustrating an example of a reconstructed frame according to one or more embodiments;

FIG. 8B is a diagram illustrating an example of a generated mask according to one or more embodiments; and

FIG. 9 is a diagram illustrating an example of a configuration of an apparatus according to one or more embodiments.

### DETAILED DESCRIPTION

The following detailed structural or functional description is provided as an example only and various alterations and modifications may be made to the examples. Accordingly, the examples are not construed as limited to the disclosure and should be understood to include all changes, equivalents, and replacements within the idea and the technical scope of the disclosure.

In connection with the description of the drawings, like reference numerals may be used for similar or related components. It is to be understood that a singular form of a noun corresponding to an item may include one or more of the things, unless the relevant context clearly indicates otherwise.

As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof.

Terms such as “1st” and “2nd,” or “first” and “second” may be used to simply distinguish a corresponding component from other components, and do not limit the components in other aspects (e.g., importance or order).

It is to be understood that if a component (e.g., a first component) is referred to, with or without the term “operatively” or “communicatively,” as “coupled with,” “coupled to,” “connected with,” or “connected to” another component (e.g., a second component), the component may be coupled with the other component directly (e.g., wiredly), wirelessly, or via a third component.

The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, the embodiments will be described in detail with reference to the accompanying drawings. When describing the examples with reference to the accompanying drawings, like reference numerals refer to like elements and any repeated description related thereto will be omitted.

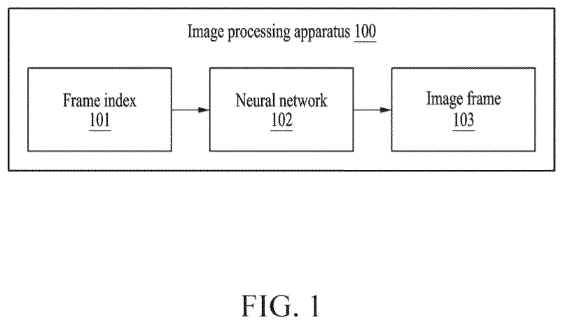

FIG. 1 is a diagram illustrating a neural network-based image processing flow according to one or more embodiments.

Referring to FIG. 1, an image processing apparatus 100 may reconstruct an image frame 103 at a corresponding time point through a neural network 102 in correspondence to an input frame index 101. The frame index 101 may be, for example, an integer-type time point value, but may be input in various forms such as normalized continuous temporal coordinates, timestamps, or position-based coordinate values.

In one or more embodiments, training of the neural network 102 may be understood as a model fitting process that fits an entire given image to one neural network 102. In a training stage, the image processing apparatus 100 may optimize parameters of the neural network 102 to approximately predict color information (for example, red, green, and blue (RGB) values) of pixels included in an image frame corresponding to each frame index 101. The image processing apparatus 100 may train the neural network 102 using an entire image sequence as input-output pairs, thereby internalizing image data within the neural network 102. In this case, the neural network 102 may be a single model, or may be a set of a plurality of sub-models divided according to temporal intervals or resolutions.

When training of the neural network 102 is completed, the image frame 103 at a corresponding time point may be reconstructed by merely inputting the frame index 101 to the neural network 102. This reconstruction process may be performed only by forward inference on the neural network 102. The reconstruction process may be implemented as a single operation step, or may be implemented as a structure including, for example, multi-stage upsampling or post-processing operations.

A detailed structure of the neural network 102 included in the image processing apparatus 100 will be described more specifically with reference to drawings described below. However, each configuration is merely a processing flow according to one or more embodiments, and implementation methods thereof may be modified and applied in various forms.

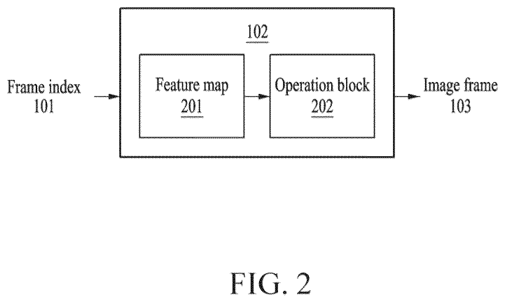

FIG. 2 is a diagram illustrating a neural network architecture according to one or more embodiments.

Referring to FIG. 2, the neural network 102 may generate an image frame 103 corresponding to a frame index 101 provided as input. An image processing apparatus including the neural network 102 of FIG. 2 may correspond to the image processing apparatus 100 of FIG. 1.

In one or more embodiments, the neural network 102 may be defined as a function (f_{θ}) that maps temporal coordinates to image frames, and the architecture of the neural network 102 may be represented as a function as shown in Equation 1 below. The temporal coordinates represent information corresponding to frame indices, and may be, for example, temporal information indicating where an image frame of a specific frame index is located within an entire image (for example, a video). The temporal information may refer to the temporal position of an image frame within a complete image sequence (e.g., a video). The neural network 102 may be implemented as an image regression structure that directly predicts image data at a corresponding time point based on an input frame index.

f_{θ}(t):R→R^{C}×H×W [Equation 1]

Here, H and W may represent the height and width of an image frame, respectively, and C represents the number of output channels. The frame index corresponding to input data of the neural network 102 may be data of a one-dimensional channel (R). In other words, the input t∈R may be a one-dimensional temporal coordinate (or frame index). The image frame corresponding to output data of the neural network 102 may be data of a three-dimensional channel (R^{C}) of H×W size. In an implementation, C=3 corresponds to RGB color channels (i.e., red, green, and blue) that define the color composition of each pixel. However, the output dimensionality is not limited to RGB. For example, C=4 may represent RGBA data, where the additional “A” (alpha) channel encodes transparency or opacity information for each pixel, with a value typically normalized between 0 (fully transparent) and 1 (fully opaque). Furthermore, the output channels may be extended to represent various modalities, such as image masks, depth maps, optical flow fields, or semantic segmentation maps, depending on the application context.

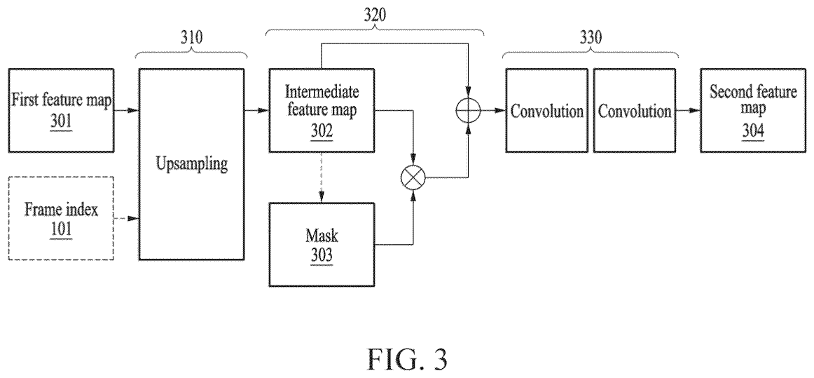

Training of the neural network 102 may be performed by a model fitting method that optimizes parameters to approximately predict an actual image frame 103 at a corresponding time point in correspondence to an input frame index 101. In this case, training data may include a set of input-output pairs (tᵢ, Iᵢ), where tᵢ, denotes a frame index (temporal coordinate) and Iᵢ denotes a corresponding ground-truth image frame within an entire image sequence. A loss function according to one or more embodiments may be defined to measure differences between predicted image frames and ground-truth image frames, and parameters (e.g., weights and biases) of the neural network 102 may be iteratively updated via gradient-based optimization in a direction that minimizes this loss. The loss may be considered minimized when the change in loss value between successive iterations falls below a predetermined margin (tolerance), or when it reaches or falls below a predefined acceptable value. Both conditions may be combined or used separately, depending on implementation. A specific configuration of the loss function will be described in more detail with reference to FIG. 3 below.

According to one or more embodiments, the neural network 102 may include a structure that embeds temporal information as high-dimensional features and generates a feature map 201 based on the embedded representation.

Here, embedding may refer to a process of expanding a single scalar value (for example, frame index) into a vector having richer expressiveness (e.g., richer descriptive power). Embedding may be implemented in various ways such as, for example, sine/cosine-based periodic functions (positional encoding), learnable vector tables, or methods that map inputs to multi-dimensional grids. Through this embedding process, the neural network 102 may be configured to nonlinearly represent and more precisely model continuous changes of frames according to temporal coordinates.

In one or more embodiments, embedding may be implemented by a multi-resolution temporal grid method including a plurality of temporal resolutions. Here, the temporal grid may refer to a structure that divides a temporal axis at regular intervals and stores feature information corresponding to each temporal interval. Temporal resolution may define how finely the entire sequence duration will be divided, and having high temporal resolution may mean that changes in shorter temporal intervals can be reflected.

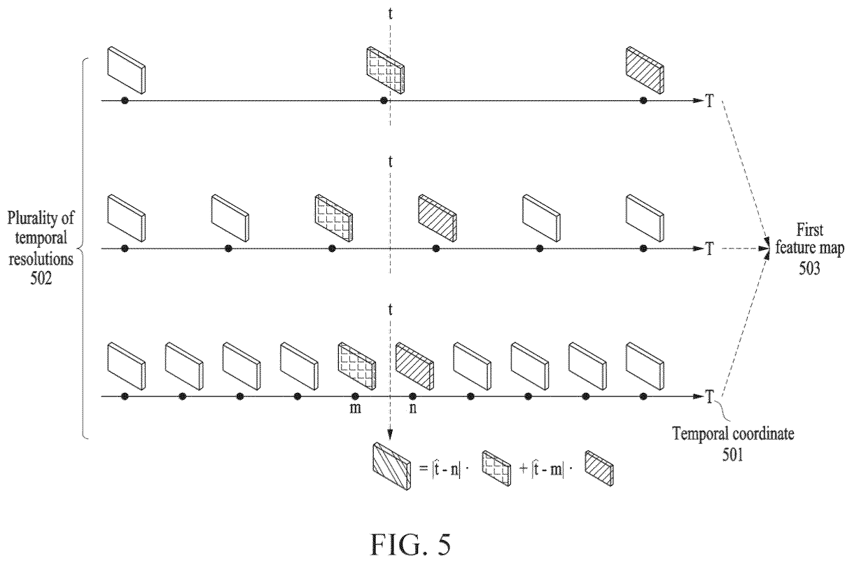

For example, a grid with a resolution of 64 may be configured to capture relatively slow temporal changes by dividing an entire image sequence into 64 intervals. A grid with a resolution of 512 may be configured to reflect even minute changes between frames by dividing the temporal axis more finely. By using a plurality of grids having different temporal resolutions in this manner, information of various temporal scales from overall temporal flow of images to detailed changes can be represented. The configuration of such a multi-resolution temporal grid and an embedding structure by temporal interpolation will be described in more detail with reference to FIG. 5 described below.

According to one or more embodiments, the neural network 102 may include at least one operation block 202 that reconstructs the image frame 103 based on the feature map 201.

The operation block 202 may include, for example, upsampling operations and convolution operations. Here, upsampling may refer to an operation that increases spatial resolution of an input feature map to expand low-resolution representation to high-resolution representation. In one or more embodiments, upsampling may be performed by a pixel shuffle (PixelShuffle) method or a bilinear interpolation method, but is not limited thereto. Convolution operations may refer to operations that extract information of local regions or combine features by applying filters (or kernels). In one or more embodiments, convolution operations may be performed through two-dimensional convolution layers, but are not limited thereto. A specific configuration and operating method of the operation block 202 will be described in more detail with reference to FIG. 3 described below.

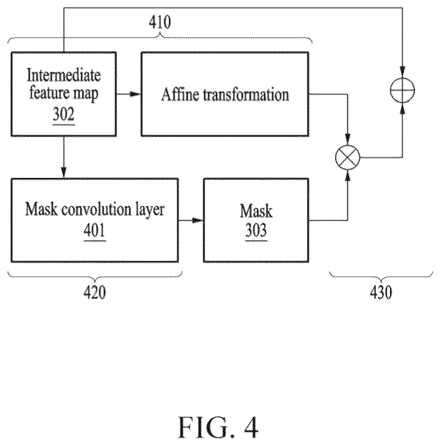

The operation block 202 according to one or more embodiments may include a convolution layer that generates a mask related to a high-frequency component and an operation layer that calibrates feature maps based on the mask. The operation block 202 may include a mask-based operation block. The mask-based operation block is basically a frame-level representation method in the form of a neural network-based function that receives temporal indices as input and generates all frames at corresponding time points. The mask-based operation block can prevent learning and inference speed degradation by preventing computational complexity from rapidly increasing even when the resolution and number of frames are large. The mask-based operation block can provide technology that is robust not only to low-frequency component information included in image frames but also to high-frequency component information or detailed representation when using coordinate information as input. Specific descriptions of mask generation and application will be described in more detail with reference to FIGS. 3 and 4 described below.

The image processing apparatus according to one or more embodiments may generate high-resolution image frames 103 progressively from the feature map 201 by hierarchically configuring the operation blocks 202. According to embodiments, nonlinear activation functions (for example, a rectified linear unit (ReLU) or a Gaussian error linear unit (GeLU)) and normalization layers may be added to each operation block 202 to improve expressiveness and training stability of the neural network 102.

After training of the neural network 102 is completed, the image frame 103 at a corresponding time point may be output according to an inference method, based on a frame index 101 given as input. That is, the image processing apparatus may reconstruct the image frame 103 at a corresponding time point through forward operations without additional optimization processes, based on learned parameters.

The image processing apparatus according to one or more embodiments may save storage space and improve inference efficiency by compressing the neural network 102 when training is completed. Standard techniques widely used in the deep learning field may be applied to compression of the neural network 102. For example, model pruning that removes connections with low importance, weight quantization that simultaneously reduces computational complexity and model size by reducing precision of weight representation, and/or weight encoding methods that represent repetitive weight patterns in compressed form may be used.

FIG. 3 is a diagram for specifically illustrating a structure of an operation block according to one or more embodiments. FIG. 3 may be a diagram showing a structure of the operation block 202 included in the neural network 102 illustrated in FIGS. 1 and 2.

Referring to FIG. 3, the operation block may generate an intermediate feature map 302 by upsampling a first feature map 301 provided as input. The operation block may calibrate the intermediate feature map 302 based on a mask 303 related to a high-frequency component and output a second feature map 304 by performing at least one convolution operation 330.

According to one or more embodiments, the neural network may include at least one operation block. The first feature map 301 provided as input to the first operation block may correspond to the feature map 201 of FIG. 2.

The operation block may generate the intermediate feature map 302 by applying an upsampling operation 310 to the first feature map 301 corresponding to the frame index 101 provided as input.

Upsampling may be performed by, for example, a PixelShuffle or a bilinear interpolation method, but is not limited thereto. Additionally, according to embodiments, additional encoding operations for improving expressiveness or precision of upsampling results may be performed in combination.

The PixelShuffle may refer to a technique that expands resolution by rearranging high-resolution information distributed in a channel direction to spatial dimensions. For example, when a resolution expansion ratio is r, the operation block may receive an input feature map composed of channel number C, height H, and width W (for example, a tensor of C×H×W size) and expand spatial resolution by rearranging the input feature map to a

$$\frac{C}{{r}^{2}} \times ( H \cdot r ) \times ( W \cdot r )$$

size. Here, C may refer to the number of channels of the input tensor, H and W may refer to the height and width of the input feature map, and r may refer to a ratio for expanding spatial resolution.

The bilinear interpolation method may refer to a technique that expands resolution by estimating new pixel values by calculating weighted averages based on four spatially adjacent pixel values. In one or more embodiments, the operation block may perform upsampling by applying bilinear interpolation on a frame-by-frame basis to feature maps of entire image frames. For example, the operation block may perform upsampling by referencing four adjacent low-resolution pixel positions (i, j), (i+1, j), (i, j+1), (i+1, j+1) for high-resolution coordinates (x, y) and estimating values at corresponding positions by multiplying pixel values at each position by linear interpolation weights. In this case, weights may be calculated based on decimal positions of (x, y) coordinates, and final values may be calculated based on results of performing linear interpolation in horizontal and vertical directions, respectively.

According to one or more embodiments, the operation block may additionally include or use in combination a local grid-based encoding structure to improve expressiveness or precision of upsampling results. Here, the local grid may refer to relative spatial coordinates of corresponding positions defined based on each position of the upsampled high-resolution feature map, that is, normalized relative coordinate values. For example, the operation block may calculate normalized relative coordinate values based on an upsampling factor (for example, resolution expansion ratio r) for each position of the high-resolution feature map. The operation block may extract information of adjacent grid points from a plurality of local grids by linear interpolation using normalized relative coordinate values as input and generate positional features corresponding to each position. The generated positional features may be added to the upsampled feature map or connected in a channel direction, thereby generating the intermediate feature map 302. According to embodiments, interpolation may be performed in various ways such as Gaussian weight-based interpolation, polynomial regression-based interpolation, or pre-trained coordinate-feature mapping functions.

At least one convolution operation may be additionally performed to enhance spatial continuity and local structural information of the upsampled feature map. Convolution operations may be performed, for example, by applying convolution filters. According to embodiments, the convolution operations may be combined with nonlinear activation functions (for example, ReLU, GeLU, and the like) and/or normalization layers (for example, batch normalization or instance normalization, and the like).

The operation block may generate the mask 303 related to a high-frequency component corresponding to the intermediate feature map 302 and calibrate 320 the intermediate feature map 302 based on the mask 303.

Here, a high-frequency component may refer to a local region where changes in brightness or color between pixels are abrupt (for example, boundaries, contours, textures, and the like). Generally, neural network structures that use low-dimensional coordinates as input may have a bias that preferentially learns low-frequency components. The operation block may mitigate representation loss due to such bias and improve sharpness and/or boundary information of all frames by applying the mask 303 related to a high-frequency component to the intermediate feature map 302. For example, the operation block may generate the mask 303 that reflects high-frequency component information corresponding to features of the intermediate feature map 302 and improve expressiveness by performing weighted calibration of values at each position of the intermediate feature map 302 based on the mask 303.

According to one or more embodiments, the mask 303 may be generated through spatial filtering that emphasizes the high-frequency component and suppresses a low-frequency component among frequency components of the intermediate feature map 302.

For example, depth-wise separable convolution operations designed to sensitively extract a high-frequency component such as a boundary may be used. Here, depth-wise separable convolution may refer to an operation that applies spatially independent convolution filters to each channel without mutual interference between channels. Convolution operations may be designed to output relatively large values in boundary regions where abrupt brightness changes appear, based on differences between center pixels and surrounding pixels within filters. In this case, at least one filter for spatial filtering may include learnable parameters.

According to one or more embodiments, the operation block may transform the intermediate feature map 302 and apply the mask 303 to the transformed intermediate feature map.

Prior to applying the mask 303 to the intermediate feature map 302, the operation block may adjust the intermediate feature map 302 to a form suitable for mask application. For example, the operation block may align ranges and channel structures of the intermediate feature map 302 with the mask 303 by adjusting channel-wise distributions of the intermediate feature map 302 or performing operations that generate normalized feature representations.

Application of masks may be implemented in various ways such as residual connection methods, addition or linear combination methods, gate methods, or attention-based position weighting methods, in addition to simple multiplication methods. The operation block may apply the mask 303, for example, by multiplying mask values as weights corresponding to each position of the intermediate feature map 302.

Specific methods for transforming the intermediate feature map 302 and applying the mask 303 will be described in more detail with reference to FIG. 4.

The operation block may output a second feature map 304 by performing at least one convolution operation 330 on the calibrated intermediate feature map.

Convolution operations 330 may be performed to enhance spatial consistency and local features of the calibrated intermediate feature map and improve expressiveness. The operation block may generate a progressively refined second feature map 304 from the calibrated intermediate feature map by, for example, hierarchically configuring a plurality of two-dimensional convolution layers. According to embodiments, the convolution operations may be combined with nonlinear activation functions (for example, ReLU, GeLU, and the like) and/or normalization layers (for example, batch normalization or instance normalization, and the like).

According to one or more embodiments, the neural network may include at least one operation block 202. Although not illustrated, the neural network may finally reconstruct image frames by performing additional operations (for example, 1×1 convolution layers and/or nonlinear activation functions) on a feature map output from the last operation block.

During the training process, a reconstructed image frame may be compared with a ground-truth frame and used to calculate loss functions. Loss functions may be defined based on the difference between a reconstructed image frame and a ground-truth frame. Calculated losses may then be utilized in backpropagation processes for optimizing parameters of the neural network. According to embodiments, loss functions may be defined as single criteria or weighted combinations of multiple losses.

According to one or more embodiments, the image processing apparatus may calculate a first loss based on image frames corresponding to the second feature map and ground-truth frames. The first loss may be calculated as a weighted combination of L₁ loss representing absolute differences between pixels and multi-scale structural similarity index measure (MS−SSIM) loss representing structural similarity between two images (e.g., how similar two images are in terms of luminance, contract, and structure across multiple spatial scales). For example, the first loss may be defined as α×L₁+β×MS−SSIM, where a and β may weighting coefficients. α may control the influence of L₁ loss, emphasizing pixel-level fidelity, and β may control the influence of the MS−SSIM loss, emphasizing perceptual and structural similarity. For example, a may be set to 0.7 and β may be set to 0.3.

According to one or more embodiments, the image processing apparatus may generate a ground-truth mask from a ground-truth frame and additionally calculate a second loss based on the difference between the generated ground-truth mask and a mask output from the operation block. The second loss may be included in overall training loss as a weighted term, and the overall training loss may be configured, for example, as shown in Equation 2 below.

$${L}_{total} = α \times {L}_{1} ( reconstructed frame , ground truth frame ) + β \times MS - SSIM ( reconstructed frame , ground truth frame ) + γ \times {L}_{1} ( mask , ground truth mask ) \qquad [ Equation 2 ]$$

Here, α, β, γ are coefficients that control contributions of each loss, and for example, α may be set to 0.7, β may be set to 0.3, and γ may be set to 0.01.

In one or more embodiments, the ground-truth mask may be generated by performing Gaussian filtering on the ground-truth frame, but is not limited thereto. For example, the image processing apparatus may generate a ground-truth mask with an emphasized high-frequency component by subtracting the results of applying Gaussian blur from the ground-truth frame and applying a normalization operation to the subtraction result. The ground-truth mask may be generated, for example, by applying Equation 3 below.

M_{GT}=sigmoid(20×(I_{GT}−GaussianBlur(I_{GT}))) [Equation 3]

Gaussian blur may be used to remove low-frequency components from the ground-truth frame and generate results that emphasize high-frequency information such as a boundary or texture. Gaussian blur may refer to, for example, a Gaussian filter having a kernel size of 11 and a standard deviation (sigma) of 5.0. A sigmoid function may be used to convert emphasized high-frequency components to a normalized mask in a [0, 1] range.

In one or more embodiments, the first loss and the second loss may be applied to the image frame and mask corresponding to the feature map output from the last operation block, respectively. The calculated loss values may be utilized in backpropagation processes for optimizing parameters of neural networks, and precision of reconstructed frames and masks may be progressively improved through iterative training.

FIG. 4 is a diagram for illustrating a structure of mask generation and application according to one or more embodiments.

Referring to FIG. 4, the operation block may calibrate the intermediate feature map 302 by transforming the intermediate feature map 302 and applying the mask 303 to the transformed intermediate feature map. Operations of FIG. 4 may correspond to operation 320 of FIG. 3.

According to one or more embodiments, the operation block may transform 410 the intermediate feature map 302 through an affine transformation.

Here, an affine transformation may refer to a channel-wise linear transformation that adjusts input feature values by applying a scale parameter (γ) and a shift parameter (β) to each channel. The operation block may align ranges and channel structures of the intermediate feature map 302 to be suitable for application of the mask 303 by performing, for example, an affine transformation including a scale parameter γ and a shift parameter β on the intermediate feature map 302. This operation may be expressed as F′=γ⊗F+β, wherein F denotes the input intermediate feature map 302, F′ denotes the transformed feature map, and ⊗ represents element-wise multiplication. In one or more embodiments, the scale parameter γ and shift parameter β used in an affine transformation may be set as learnable parameters that is jointly trained with the neural network to optimize the alignment and calibration process.

According to one or more embodiments, the operation block may perform convolution 420 to generate the mask 303 by passing the intermediate feature map 302 through an additional convolution layer.

For convenience of description, a convolution layer for generating a mask is hereinafter referred to as a mask convolution layer 401. The mask convolution layer 401 may perform spatial filtering that emphasizes the high-frequency component and suppresses a low-frequency component that is less than a predetermined lower frequency threshold, among frequency components of the intermediate feature map 302. For example, depth-wise separable convolution that applies spatially independent convolution filters to each channel may be used to sensitively extract a high-frequency component such as a boundary. In this case, at least one filter for spatial filtering may include learnable parameters.

According to embodiments, the mask convolution layer 401 may improve expressiveness of a mask by applying a nonlinear activation function (for example, GeLU). Additionally, the mask convolution layer 401 may represent calibration strength at each position of a mask in a form of relative weights by applying a normalization function (for example, sigmoid function).

According to one or more embodiments, the operation block may calibrate 430 the intermediate feature map 302 based on the generated mask 303.

For example, the operation block may calibrate the intermediate feature map 302 by multiplying a mask value at a corresponding position for each position of the intermediate feature map 302 or the intermediate feature map having undergone affine transformation and adding the result to the intermediate feature map 302. The mask application method is not limited thereto, and may be replaced or supplemented with a residual connection method, addition or linear combination method, or attention-based position weighting method, and the like, according to embodiments.

FIG. 5 is a diagram for illustrating a configuration of a multi-resolution temporal grid and an embedding structure by temporal interpolation according to one or more embodiments.

The neural network of FIG. 5 may correspond to the neural network 102 illustrated in FIGS. 1 and 2.

Referring to FIG. 5, the neural network may generate a first feature map 503 by performing interpolation from a grid including a plurality of temporal resolutions 502 based on information corresponding to a frame index (for example, normalized temporal coordinates).

Here, the temporal coordinate 501 may be defined as a continuous coordinate normalized according to the total number of frames based on a frame index. In one or more embodiments, each temporal resolution grid may be composed of grid points that equally divide a temporal axis at regular intervals.

The neural network may generate a feature map at a corresponding time point by performing linear interpolation based on positions of two grid points adjacent to an input temporal coordinate t, corresponding to each of the plurality of temporal resolutions 502. For example, the neural network may generate an interpolated feature map φ(t, G) through linear interpolation as shown in Equation 4 below.

φ(t,G)=|\hat{t}−n|·G[m]+|\hat{t}−m|·G[n] [Equation 4]

Here, t may refer to a frame index, T may refer to the total number of frames, s may refer to a temporal resolution of a corresponding grid, and a normalized temporal coordinate \hat{\tilde{t}} may refer to

$$\hat{t} = \frac{t \cdot s}{T} .$$

Additionally, m=\hat{t} and n=[\hat{t}] may refer to adjacent integer time points of \hat{t}, and G [m] and G [n] may refer to feature maps corresponding to indices m and n in a corresponding grid. In this equation, two feature maps G[m] and G[n] are combined based on how close the normalized temporal coordinate \hat{\tilde{t}} is to each grid point, to generate the interpolated feature map φ(t, G).

For example, it is assumed that the total number of frames is 600, a frame index t is 251, and φ(251, G) is obtained from a grid configured with a resolution of 64. Since a normalized temporal coordinate \hat{t} becomes

$$\hat{t} = \frac{251.64}{600} \approx 26.77 ,$$

adjacent time points m and n become 26 and 27, respectively. By interpolating feature maps G[26] and G[27] using Equation 4, φ(251, G) can be calculated.

Interpolation results calculated from grids for each resolution have the same spatial resolution (H×W). The neural network may form a final first feature map 503 by sequentially concatenating interpolation results based on a channel dimension. According to embodiments, interpolated feature maps may be combined in various ways such as weighted sum, attention-based fusion, and the like, in addition to concatenation.

FIG. 5 illustrates temporal resolution grids 502 having three different resolutions arranged side by side. Each temporal resolution grid is composed of grid points that equally divide a temporal axis at fixed intervals. Referring to FIG. 5, it can be confirmed that as resolution increases, density of grid points on a temporal axis becomes denser. A first feature map 503 corresponding to an input temporal coordinate t can be configured by linearly interpolating feature maps of corresponding points based on two grid points m and n closest to the input temporal coordinate t at each temporal resolution and combining corresponding results.

According to one or more embodiments, positions of a plurality of grid points included in a temporal resolution grid may not be arranged at fixed intervals, but may be adaptively arranged according to feature variation over time.

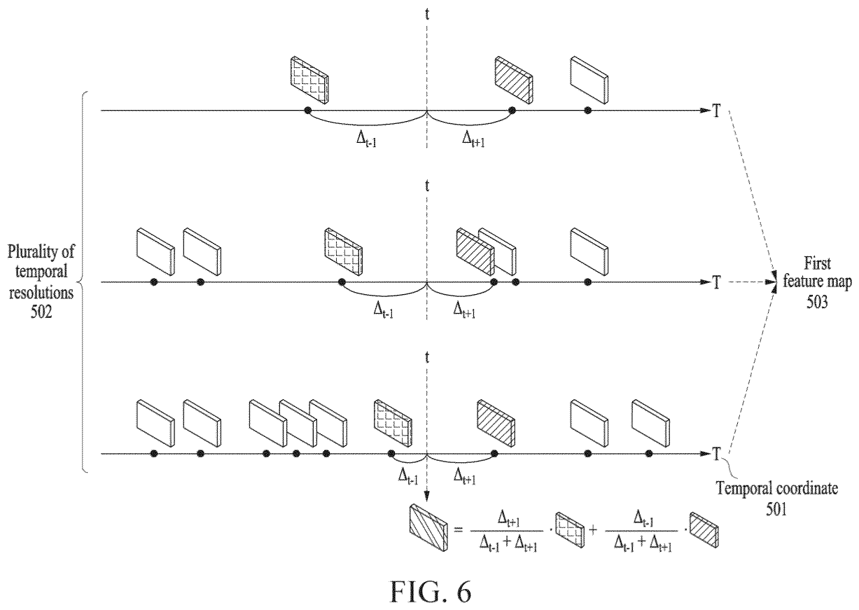

For example, the image processing apparatus may be configured to efficiently allocate feature representation on a temporal axis according to variation by setting intervals of grid points densely in sections with large temporal variation and setting intervals widely in sections with relatively small variation. In one or more embodiments, positions of grid points or intervals between points may be set as learnable parameters, allowing the neural network to adjust sampling density on a temporal axis through training. An interpolation structure based on such adaptive sampling will be described in more detail with reference to FIG. 6 described below.

FIG. 6 is a diagram for illustrating an implementation method of an interpolation structure based on an adaptive temporal coordinate according to one or more embodiments.

The neural network of FIG. 6 may correspond to the neural network 102 illustrated in FIGS. 1 and 2.

Referring to FIG. 6, the neural network may generate a first feature map 503 by a linear interpolation method corresponding to the temporal coordinate 501. In this case, interpolation for the temporal coordinate t and the temporal resolution grid G may be defined as shown in Equation 5 below, similar to Equation 4 of FIG. 5.

$$φ ( t , G ) = \frac{{Δ}_{t + 1}}{{Δ}_{t - 1} + {Δ}_{t + 1}} \cdot {G}_{t - 1} + \frac{{Δ}_{t - 1}}{{Δ}_{t - 1} + {Δ}_{t + 1}} \cdot {G}_{t + 1} \qquad [ Equation 5 ]$$

Here, Δₜ₋₁ may refer to a distance between a temporal coordinate t and a previous grid point Gₜ₋₁, and Δₜ₊₁ may refer to a distance between temporal coordinate t and a next grid point Gₜ₊₁.

$$\frac{{Δ}_{t + 1}}{{Δ}_{t - 1} + {Δ}_{t + 1}} and \frac{{Δ}_{t - 1}}{{Δ}_{t - 1} + {Δ}_{t + 1}}$$

may be used as weights for linear interpolation and configured so that larger weights are applied to grids at closer positions.

Unlike Equation 4, Δₜ₋₁ and Δₜ₊₁ in Equation 5 may be defined as differences between learnable temporal coordinates rather than fixed intervals (for example, fixed intervals based on frame indices). That is, by setting positions and intervals of grid points in each temporal resolution grid as learnable parameters, the neural network may be configured to adjust density of grids according to feature variation on a temporal axis.

FIG. 6 illustrates temporal resolution grids 502 having three different resolutions arranged side by side. Each temporal resolution grid is composed of learnable temporal coordinates arranged with different densities according to temporal variation. Referring to FIG. 6, it can be visually confirmed that grid points are densely distributed in sections with large differences between frames on a temporal axis, and intervals are arranged widely in sections with relatively small variation. A first feature map 503 corresponding to input temporal coordinate t 501 may be generated by linearly interpolating feature maps of corresponding points based on two grid points closest to the input temporal coordinate t 501 at each temporal resolution and combining corresponding results.

As a result, denser sampling may be performed in sections with large differences between frames and simpler sampling may be performed in sections with small changes, thereby improving efficiency of embedding.

According to embodiments, the interpolation method may be replaced or supplemented with polynomial interpolation, spline interpolation, or soft attention-based interpolation structures, in addition to linear interpolation. According to embodiments, weights used for interpolation may be set as learnable structures, in addition to intervals between temporal coordinates.

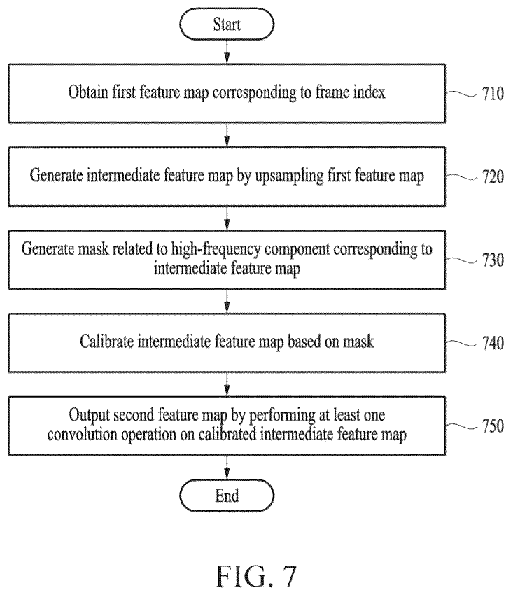

FIG. 7 is a diagram illustrating an overall flow of an image processing method according to one or more embodiments.

The image processing method according to one or more embodiments described with reference to FIG. 7 may be performed by a processor of an electronic apparatus. The specific hardware configuration of the electronic apparatus is described in detail below. According to one or more embodiments, operations 710 to 750 may be operations performed by the image processing apparatus 100 described with reference to FIGS. 1 to 6.

Operations 710 to 750 included in the method described with reference to FIG. 7 may be performed sequentially but not necessarily. For example, the order of operations 710 to 750 may change, and at least two operations may be performed in parallel.

In operation 710, the image processing apparatus 100 may obtain a first feature map corresponding to a frame index. In operation 720, the image processing apparatus 100 may generate an intermediate feature map by upsampling the first feature map. In operation 730, the image processing apparatus 100 may generate a mask related to a high-frequency component corresponding to the intermediate feature map (e.g., spatial information in the feature map that represents rapid changes in pixel intensity or feature values). For example, Fourier-based high pass filtering or spatial-domain gradient filtering may be performed to generate the mask related to the high-frequency component. The high-frequency component may refer to a frequency component of the intermediate feature map that is greater than a predetermined upper frequency threshold. In operation 740, the image processing apparatus 100 may calibrate the intermediate feature map based on the mask. In operation 750, the image processing apparatus 100 may output a second feature map by performing at least one convolution operation on the calibrated intermediate feature map.

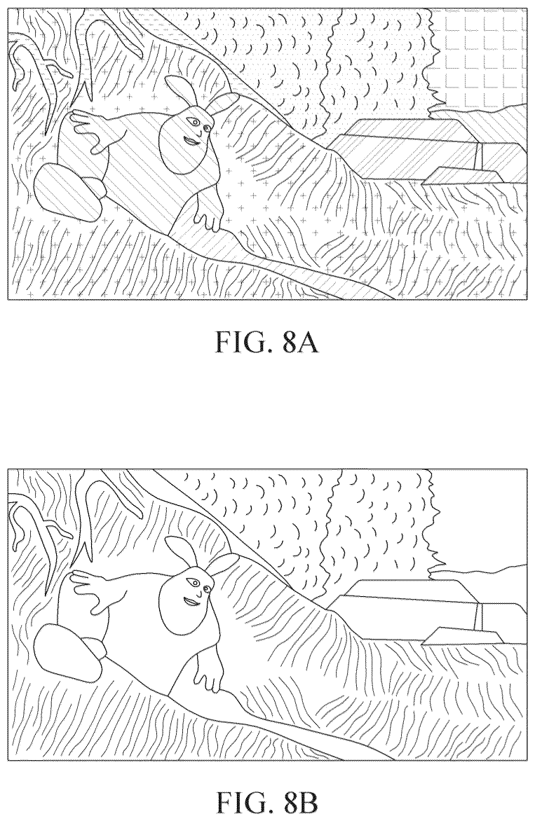

FIGS. 8A and 8B are diagrams illustrating examples of a reconstructed frame and a generated mask according to one or more embodiments.

Referring to FIGS. 8A and 8B, FIG. 8A is an example of an image frame reconstructed by an image processing apparatus according to one or more embodiments, and FIG. 8B illustrates an example of a mask generated by an operation block corresponding to the image frame.

As illustrated in FIG. 8B, the generated mask may be visualized in a form that emphasizes a high-frequency component such as a boundary, a contour, a texture, and the like within an image frame. As described above, output values of the mask are normalized between 0 and 1, and can represent relative calibration strength for each position. In one or more embodiments, the mask may be trained to have high values in regions where changes are prominent within an image (for example, boundaries of objects, detailed structures, etc.), and may be used to more strongly calibrate feature maps at corresponding positions within an operation block. Accordingly, the generated mask may contribute to improving visual quality of images and enhancing detailed representation.

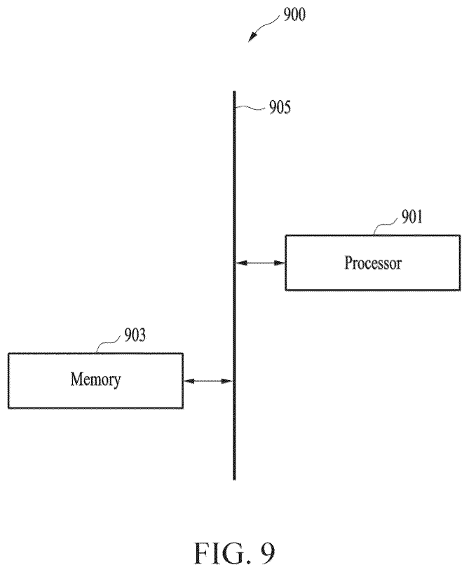

FIG. 9 is a diagram illustrating an example of a configuration of an apparatus according to one or more embodiments.

Referring to FIG. 9, an apparatus 900 according to one or more embodiments may include a processor 901, a memory 903, and a communication module 905. The apparatus 900 may include an apparatus for performing the image processing method described above with reference to FIGS. 1 to 7.

The processor 901 may perform at least one of the operations described above with reference to FIGS. 1 to 7. For example, the processor 901 may perform at least one of obtaining a first feature map corresponding to a frame index, generating an intermediate feature map by upsampling the first feature map, generating a mask related to a high-frequency component corresponding to the intermediate feature map, calibrating the intermediate feature map based on the mask, and outputting a second feature map by performing at least one convolution operation on the calibrated intermediate feature map.

The memory 903 according to one or more embodiments may be a volatile memory or a non-volatile memory and may store data related to the image processing method described above with reference to FIGS. 1 to 7. For example, the memory 903 may store data generated during a process of performing the image processing method, or data necessary for performing the image processing method. For example, the memory 903 may store data generated during a process in which an image processing apparatus generates feature maps and reconstructs image frames through operation blocks, or parameters and intermediate results for performing corresponding operations. For example, the memory 903 may store ground-truth frames, ground-truth masks, and data necessary for loss function calculation used during training performance.

The communication module 905 according to one or more embodiments may provide a function for the apparatus 900 to communicate with another electronic device or another server through a network. The apparatus 900 may be connected to an external device (e.g., a terminal of a user, a server, or a network) through the communication module 905 and exchange data with the external device.

According to one or more embodiments, the memory 903 may not be a component of the apparatus 900 and may be included in an external device accessible by the apparatus 900. In this case, the apparatus 900 may receive data stored in the memory 903 included in the external device and may transmit data to be stored in the memory 903 through the communication module 905.

According to one or more embodiments, the memory 903 may store a program configured to implement the image processing method described above with reference to FIGS. 1 to 7. The processor 901 may execute the program stored in the memory 903 and may control the apparatus 900. Code of the program executed by the processor 901 may be stored in the memory 903.

The apparatus 900 may further include other components not shown in the drawings. For example, the apparatus 900 may further include an input/output interface including an input device and an output device as the means of interfacing with the communication module 905. In addition, for example, the apparatus 900 may further include other components, such as a transceiver, various sensors, or a database.

In one or more embodiments, an image processing method may include: obtaining an input image corresponding to a frame index; obtaining a first feature map from the input image; generating an intermediate feature map by upsampling the first feature map; generating a mask related to a high-frequency component corresponding to the intermediate feature map, the high-frequency component being greater than a predetermined upper frequency threshold; calibrating the intermediate feature map based on the mask; and outputting a second feature map by performing at least one convolution operation on the calibrated intermediate feature map.

The calibrating of the intermediate feature map may include: transforming the intermediate feature map; and applying the mask to the transformed intermediate feature map.

The transforming of the intermediate feature map may include: performing an affine transformation on the intermediate feature map, the affine transformation scaling each channel by a scale parameter γ and shifting each channel by a shift parameter β.

The generating of the mask may include: performing spatial filtering for emphasizing the high-frequency component and suppressing a low-frequency component that is less than a predetermined lower frequency threshold, among frequency components of the intermediate feature map.

The obtaining of the first feature map may include: generating the first feature map by performing interpolation on a temporal grid including a plurality of temporal resolutions, based on information corresponding to the frame index.

The first feature map may be generated by performing the interpolation based on positions of two grid points adjacent to the frame index, corresponding to each of the plurality of temporal resolutions, and positions of a plurality of grid points included in the temporal grid are adaptively arranged according to feature variation over time.

The applying of the mask to the transformed intermediate feature map may include: applying the mask as a weight corresponding to each position of the intermediate feature map.

In one or more embodiments, a neural network training method may include: (1) executing at least one neural network to: obtain a first feature map corresponding to a frame index; generate an intermediate feature map by upsampling the first feature map; generate a mask related to a high-frequency component corresponding to the intermediate feature map, the high-frequency component being greater than a predetermined upper frequency threshold; calibrate the intermediate feature map based on the mask; and output a second feature map by performing at least one convolution operation on the calibrated intermediate feature map; (2) calculating a first loss of the neural network based on an image frame corresponding to the second feature map and a ground-truth frame corresponding to the frame index; (3) generating a ground-truth mask related to the high-frequency component, based on the ground-truth frame; (4) calculating a second loss of the neural network based on the mask and the ground-truth mask; and (5) updating training parameters of the neural network based on at least one of the first loss and the second loss.

The executing of the at least one neural network may include: calibrating of the intermediate feature map based on the mask by transforming the intermediate feature map, and applying the mask to the transformed intermediate feature map.

The transforming of the intermediate feature map may include: performing an affine transformation on the intermediate feature map, the affine transformation scaling each channel by a scale parameter γ and shifting each channel by a shift parameter β, wherein γ and β are set as learnable parameters.

The executing of the at least one neural network may include: generating of the mask related to the high-frequency component by performing spatial filtering for emphasizing the high-frequency component and suppressing a low-frequency component that is less than a predetermined lower frequency threshold, among frequency components of the intermediate feature map, wherein at least one filter for the spatial filtering may include at least one learnable parameter.

The executing of the at least one neural network may include: obtaining the first feature map corresponding to the frame index by generating the first feature map by performing interpolation on a temporal grid including a plurality of temporal resolutions, based on information corresponding to the frame index.

The first feature map may be generated by performing interpolation based on positions of two grid points adjacent to the frame index, corresponding to each of the plurality of temporal resolutions, positions of a plurality of grid points included in the temporal grid may be adaptively arranged according to feature variation over time, and the positions of the plurality of grid points may be set as learnable parameters.

In one or more embodiments, a non-transitory computer-readable storage medium storing instructions that, when executed by a processor, cause the processor to perform the image processing method.

In one or more embodiments, a computing apparatus for providing image processing, may include: at least one processor; and at least one memory storing one or more instructions. The one or more instructions, when executed by the at least one processor, may cause the computing apparatus to perform: obtaining an input image corresponding to a frame index; obtaining a first feature map from the input image; generating an intermediate feature map by upsampling the first feature map; generating a mask related to a high-frequency component corresponding to the intermediate feature map, the high-frequency component being greater than a predetermined upper frequency threshold; calibrating the intermediate feature map based on the mask; and outputting a second feature map by performing at least one convolution operation on the calibrated intermediate feature map.

The calibrating of the intermediate feature map may include: transforming the intermediate feature map; and applying the mask to the transformed intermediate feature map.

The transforming of the intermediate feature map may include: performing an affine transformation on the intermediate feature map, the affine transformation scaling each channel by a scale parameter γ and shifting each channel by a shift parameter fi.

The generating of the mask related to the high-frequency component corresponding to the intermediate feature map may include: performing spatial filtering for emphasizing the high-frequency component and suppressing a low-frequency component among frequency components of the intermediate feature map.

The obtaining of the first feature map may include: generating the first feature map by performing interpolation on a temporal grid including a plurality of temporal resolutions, based on information corresponding to the frame index.

The first feature map may be generated by performing the interpolation based on positions of two grid points adjacent to the frame index, corresponding to each of the plurality of temporal resolutions, and positions of a plurality of grid points included in the temporal grid may be adaptively arranged according to feature variation over time.

The embodiments described herein may be implemented using a hardware component, a software component and/or a combination thereof. For example, the devices, the methods, and the components described in the embodiments may be implemented using a general-purpose or special-purpose computer, such as a processor, a controller and an arithmetic logic unit (ALU), a digital signal processor (DSP), a microcomputer, a field programmable gate array (FPGA), a programmable logic unit (PLU), a microprocessor, or any other devices capable of responding to and executing instructions. The processing device may run an operating system (OS) and one or more software applications that run on the OS. The processing device also may access, store, manipulate, process, and create data in response to execution of the software. For purpose of simplicity, the description of a processing device is singular; however, one of ordinary skill in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, structure, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. An image processing method, comprising:
obtaining a frame index;
obtaining a first feature map corresponding to the frame index;
generating an intermediate feature map by upsampling the first feature map;
generating a mask related to a high-frequency component corresponding to the intermediate feature map, the high-frequency component being greater than a predetermined upper frequency threshold;
calibrating the intermediate feature map based on the mask; and
outputting a second feature map by performing at least one convolution operation on the calibrated intermediate feature map.

2. The image processing method of claim 1, wherein the calibrating of the intermediate feature map comprises:
transforming the intermediate feature map; and
applying the mask to the transformed intermediate feature map.

3. The image processing method of claim 2, wherein the transforming of the intermediate feature map comprises:
performing an affine transformation on the intermediate feature map, the affine transformation scaling each channel by a scale parameter γ and shifting each channel by a shift parameter β.

4. The image processing method of claim 1, wherein the generating of the mask comprises:
performing spatial filtering for emphasizing the high-frequency component and suppressing a low-frequency component that is less than a predetermined lower frequency threshold, among frequency components of the intermediate feature map.

5. The image processing method of claim 1, wherein the obtaining of the first feature map comprises:
generating the first feature map by performing interpolation on a temporal grid comprising a plurality of temporal resolutions, based on information corresponding to the frame index.

6. The image processing method of claim 5, wherein
the first feature map is generated by performing the interpolation based on positions of two grid points adjacent to the frame index, corresponding to each of the plurality of temporal resolutions, and
positions of a plurality of grid points included in the temporal grid are adaptively arranged according to feature variation over time.

7. The image processing method of claim 2, wherein the applying of the mask to the transformed intermediate feature map comprises:
applying the mask as a weight corresponding to each position of the intermediate feature map.

8. A neural network training method, comprising:
executing at least one neural network to:
obtain a first feature map corresponding to a frame index;
generate an intermediate feature map by upsampling the first feature map;
generate a mask related to a high-frequency component corresponding to the intermediate feature map, the high-frequency component being greater than a predetermined upper frequency threshold;
calibrate the intermediate feature map based on the mask; and
output a second feature map by performing at least one convolution operation on the calibrated intermediate feature map;
calculating a first loss of the neural network based on an image frame corresponding to the second feature map and a ground-truth frame corresponding to the frame index;
generating a ground-truth mask related to the high-frequency component, based on the ground-truth frame;
calculating a second loss of the neural network based on the mask and the ground-truth mask; and
updating training parameters of the neural network based on at least one of the first loss and the second loss.

9. The neural network training method of claim 8, wherein the executing of the at least one neural network comprises:
calibrating of the intermediate feature map based on the mask by:
transforming the intermediate feature map; and
applying the mask to the transformed intermediate feature map.

10. The neural network training method of claim 9, wherein the transforming of the intermediate feature map comprises:
performing an affine transformation on the intermediate feature map, the affine transformation scaling each channel by a scale parameter γ and shifting each channel by a shift parameter β,
wherein γ and β are set as learnable parameters.

11. The neural network training method of claim 8, wherein the executing of the at least one neural network comprises:
generating of the mask related to the high-frequency component by performing spatial filtering for emphasizing the high-frequency component and suppressing a low-frequency component that is less than a predetermined lower frequency threshold, among frequency components of the intermediate feature map,
wherein at least one filter for the spatial filtering includes at least one learnable parameter.

12. The neural network training method of claim 8, wherein the executing of the at least one neural network comprises:
obtaining the first feature map corresponding to the frame index by:
generating the first feature map by performing interpolation on a temporal grid comprising a plurality of temporal resolutions, based on information corresponding to the frame index.

13. The neural network training method of claim 12, wherein
the first feature map is generated by performing interpolation based on positions of two grid points adjacent to the frame index, corresponding to each of the plurality of temporal resolutions,
positions of a plurality of grid points included in the temporal grid are adaptively arranged according to feature variation over time, and
the positions of the plurality of grid points are set as learnable parameters.

14. A non-transitory computer-readable storage medium storing instructions that, when executed by a processor, cause the processor to perform the image processing method of claim 1.

15. A computing apparatus for providing image processing, comprising:
at least one processor; and
at least one memory storing one or more instructions,
wherein the one or more instructions, when executed by the at least one processor, cause the computing apparatus to perform:
obtaining an input image corresponding to a frame index;
obtaining a first feature map from the input image;
generating an intermediate feature map by upsampling the first feature map;
generating a mask related to a high-frequency component corresponding to the intermediate feature map, the high-frequency component being greater than a predetermined upper frequency threshold;
calibrating the intermediate feature map based on the mask; and
outputting a second feature map by performing at least one convolution operation on the calibrated intermediate feature map.

16. The computing apparatus of claim 15, wherein the calibrating of the intermediate feature map comprises:
transforming the intermediate feature map; and
applying the mask to the transformed intermediate feature map.

17. The computing apparatus of claim 16, wherein the transforming of the intermediate feature map comprises:
performing an affine transformation on the intermediate feature map, the affine transformation scaling each channel by a scale parameter γ and shifting each channel by a shift parameter β.

18. The computing apparatus of claim 15, wherein the generating of the mask related to the high-frequency component corresponding to the intermediate feature map comprises:
performing spatial filtering for emphasizing the high-frequency component and suppressing a low-frequency component among frequency components of the intermediate feature map.

19. The computing apparatus of claim 15, wherein the obtaining of the first feature map comprises:
generating the first feature map by performing interpolation on a temporal grid comprising a plurality of temporal resolutions, based on information corresponding to the frame index.

20. The computing apparatus of claim 19, wherein
the first feature map is generated by performing the interpolation based on positions of two grid points adjacent to the frame index, corresponding to each of the plurality of temporal resolutions, and
positions of a plurality of grid points included in the temporal grid are adaptively arranged according to feature variation over time.
